(19) United States
(12) Patent Application Publication
(10) Pub. No.: US 2010/0215394 A1
(43) Pub. Date: Aug. 26, 2010

(54) IMAGE FORMING DEVICE

(75) Inventors: Fumio FURUSAWA, Ebina-shi (JP); Tetsuo Ishizuka, Ebina-shi (JP); Shiroh Suzuki, Ebina-shi (JP); Osamu Uto, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX Co., Ltd., Tokyo (JP)

(21) Appl. No.: 12/612,260

(22) Filed: Nov. 4, 2009

(30) Foreign Application Priority Data
Feb. 24, 2009 (JP) 2009-040759

(51) Int. Cl. G03G 21/20; G03G 15/20

(52) U.S. Cl. 399/92; 399/322

(57) ABSTRACT

An image forming device includes an image forming unit that forms a toner image; an image-transfer unit that transfers the toner image formed by the image forming unit onto an recording medium; a fixing unit that fixes the toner image transferred on the recording medium by the image-transfer unit; a conveyance path that guides the recording medium toward the image-transfer unit by changing a conveyance direction of the recording medium fixed with the toner image by the fixing unit; and a reverse path that has at least a partial overlap with the conveyance path in a vertical direction by being folded in a direction opposite to a direction of the conveyance path, and turns over the recording medium by conveying the recording medium toward the image-transfer unit from a front end portion of the recording medium conveying the recording medium toward the image-transfer unit from a front end portion of the recording medium to a rear end portion of the recording medium.

### CROSS-REFERENCE TO RELATED APPLICATIONS

This application is based on and claims priority under 35 USC 119 from Japanese Patent Application No. 2009-040759 filed Feb. 24, 2009.

### BACKGROUND

1. Technical Field

The present invention relates to an image forming device.

2. Related Art

### SUMMARY

According to an aspect of the invention, there is provided an image forming device including: an image forming unit that forms a toner image; an image-transfer unit that transfers the toner image formed by the image forming unit onto an recording medium; a fixing unit that fixes the toner image transferred on the recording medium by the image-transfer unit; a conveyance path that guides the recording medium toward the image-transfer unit by changing a conveyance direction of the recording medium fixed with the toner image by the fixing unit; and a reverse path that has at least a partial overlap with the conveyance path in a vertical direction by being folded in a direction opposite to a direction of the conveyance path, and turns over the recording medium by conveying the recording medium toward the image-transfer unit from a front end portion of the recording medium to a rear end portion of the recording medium.

### BRIEF DESCRIPTION OF THE DRAWINGS

Exemplary embodiments of the present invention will be described in detail based on the following figures, wherein:

FIG. 1 is a schematic diagram showing the entire configuration of an image forming device in an exemplary embodiment of the invention;

FIG. 2 is a side view of an image forming unit, in the form of a visible image, provided to the image forming device in the exemplary embodiment of the invention;

FIG. 3A is a perspective view of a vacuum conveying device provided to the image forming device in the exemplary embodiment of the invention;

FIG. 3B is a side view of the vacuum conveying device of FIG. 3A;

FIG. 4 is a side view of a fixing unit provided to the image forming device in the exemplary embodiment of the invention;

FIG. 5 is a perspective view of a heat sink in a cooling unit provided to the image forming device in the exemplary embodiment of the invention;

FIG. 6 is a diagram showing the configuration of a decal processing unit provided to the image forming device in the exemplary embodiment of the invention;

FIGS. 7A and 7B are each a side view of a cam member or others in the decal processing unit provided to the image forming device in the exemplary embodiment of the invention;

FIG. 8 is a diagram showing the configuration of the decal processing unit provided to the image forming device in the exemplary embodiment of the invention;

FIGS. 9A and 9B are each another side view of the cam member or others in the decal processing unit provided to the image forming device in the exemplary embodiment of the invention;

FIGS. 10A and 10B are each a side view of a curled sheet member to be straightened by the decal processing unit provided to the image forming device in the exemplary embodiment of the invention;

FIG. 11 is a diagram showing the configuration of an in-line sensor unit provided to the image forming device in the exemplary embodiment of the invention; and

FIG. 12 is a diagram showing the configuration of a power unit provided to the image forming device in the exemplary embodiment of the invention.

### DETAILED DESCRIPTION

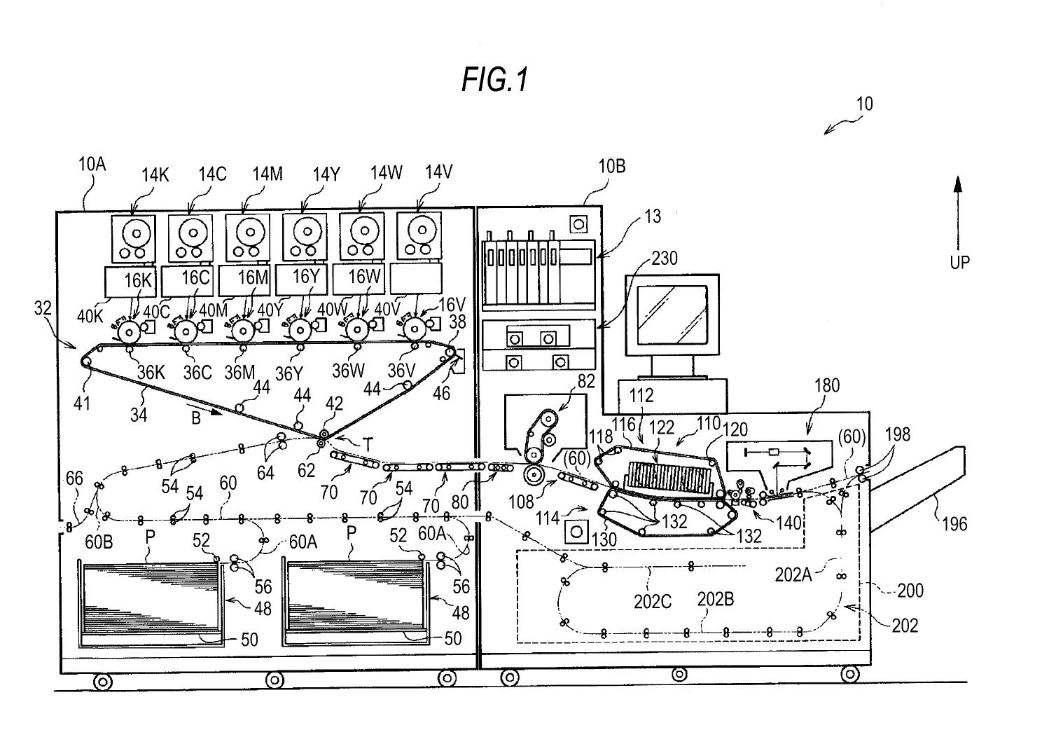

By referring to FIGS. 1 to 12, described is an exemplary image forming device in an exemplary embodiment of the invention.

### Entire Configuration

As shown in FIG. 1, an image forming device 10 in the exemplary embodiment is for forming full-color or black-and-white images, and is configured to include first housing 10A and second housing 10B. The first housing 10A is disposed on one side in the horizontal direction, i.e., on the left side of FIG. 1, and the second housing 10B is disposed to be able to be separated from the first housing 10A on the remaining side in the horizontal direction, i.e., on the right side of FIG. 1.

The second housing 10B is provided therein with an image signal processing section 13 on the upper portion in the vertical direction. The image signal processing section 13 is in charge of image processing to image data coming from a computer or others.

### Toner Cartridge

On the other hand, the first housing 10A is provided therein with a plurality of toner cartridges 14 on the upper portion in the vertical direction. These toner cartridges 14 include 14V, 14W, 14Y, 14M, 14C, and 14K that respectively carry toners of first special color (V), second special color (W), Yellow (Y), Magenta (M), Cyan (C), and Black (K). These toner cartridges are arranged in the horizontal direction to be exchangeable.

Herein, the first and second special colors are selected as appropriate from special colors (including transparent color) other than Yellow, Magenta, Cyan, and Black. In the below, for color differentiation, the reference numeral is accompanied by any of V, W, Y, M, C, and K, and when no such color differentiation is required, V, W, Y, M, C, and K are not provided to the reference numeral as such.

Beneath such toner cartridges 14, six image forming units 16 corresponding to the toners varying in color are disposed in the horizontal direction to have a one-to-one relationship with the six toner cartridges 14. Between each pair of the toner cartridge 14 and the image forming unit 16, a light exposure unit 40 is disposed.

### Light Exposure Unit

The light exposure unit 40 provided to each of the image forming units 16 is so configured as to modulate a semiconductor laser (not shown) in accordance with gray-scale data of a color material after receiving image data completed with the image processing by the image signal processing section 13 described above. From the resulting semiconductor lasers, the light exposure unit 40 then outputs light-exposure lights L in accordance with the gray-scale data.

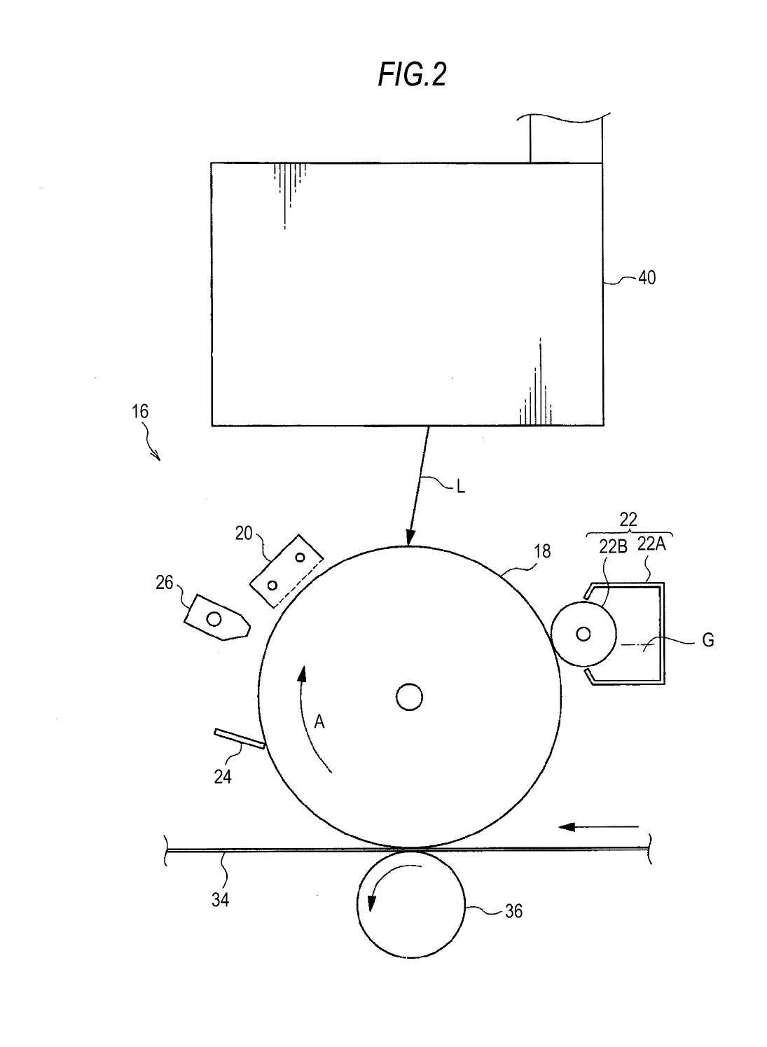

More in detail, a photosensitive element 18 that will be described later (refer to FIG. 2) is exposed to, on the surface, the light-exposure lights L corresponding to the colors, i.e., LV, LW, LY, LM, LC, and LK, thereby forming an electrostatic latent image on the photosensitive element 18.

As is known also from FIG. 1, the light exposure units 40 are provided adjacent to the image signal processing section 13, which is provided inside of the second housing 10B. This configuration favorably leads to a shorter wiring between the image signal processing section 13 and the light exposure units 40.

### Image Forming Unit

As shown in FIG. 2, the image forming units 16 are each provided with the photosensitive element 18, which is driven to rotate in the direction of an arrow A, i.e., clockwise direction. The photosensitive element 18 is provided therearound with a scorotron charger 20, a developing device 22, a cleaning blade 24, and an erase lamp 26. The scorotron charger 20 is an exemplary charger device that uniformly charges the photosensitive element 18, and is of a corona discharge type, i.e., no-contact charge type. The developing device 22 is for developing an electrostatic latent image formed on the photosensitive element 18 by a light-exposure light L directed from the corresponding light exposure unit 40 using a developing agent varying in color, i.e., toner. The cleaning blade 24 is for cleaning the surface of the photosensitive element 18 completed with the image transfer. The erase lamp 26 is an exemplary diselectrifying device that directs a light to the surface of the photosensitive element 18 completed with the image transfer to eliminate electricity therefrom.

These components, i.e., the scorotron charger 20, the developing device 22, the cleaning blade 24, and the erase lamp 26, are disposed opposite to the surface of the photosensitive element 18 in this order from the upstream to downstream side thereof in the direction of rotation.

The developing device 22 is disposed on the side of the image forming unit 16, i.e., on the right side of the drawing in the exemplary embodiment, and is configured to include a developing agent housing member 22A, and a developing roll 22B. The developing agent housing member 22A is filled with a developing agent G including a toner, and the developing roll 22B is for moving the toner filled in the developing agent housing member 22A to the surface of the photosensitive element 18. The developing agent housing member 22A is connected to the corresponding toner cartridge 14 (refer to FIG. 1) through a toner supply path (not shown) so that the toner is provided from the toner cartridge 14.

### Image-Transfer Unit

As shown in FIG. 1, an image-transfer unit 32 is disposed below the image forming units 16. The image-transfer unit 32 is configured to include an intermediate image-transfer belt 34, and six primary image-transfer rolls 36. The intermediate image-transfer belt 34 is shaped like a pulley being in contact with each of the photosensitive elements 18. The primary image-transfer rolls 36 are disposed inside of the intermediate image-transfer belt 34 for serving as six primary image-transfer members that operate multi-layer image transfer of toner images formed on the photosensitive elements 18 to the intermediate image-transfer belt 34.

Such an intermediate image-transfer belt 34 is wound around various rolls with a constant tension, i.e., a drive roll 38 driven by a motor (not shown), a tension-providing roll 41, a backup roll 42, and a plurality of tension rolls 44. The tension-providing roll 41 is for adjusting the tension of the intermediate image-transfer belt 34, and the backup roll 42 is disposed opposite to a secondary image-transfer roll 62 that will be described later. The intermediate image-transfer belt 34 is driven by the driven roll 38 to circulate in the direction of an arrow B of FIG. 1, i.e., counterclockwise direction.

More in detail, the primary image-transfer rolls 36 are respectively disposed opposite to the photosensitive elements 18 in the image forming units with the intermediate image-transfer belt 34 sandwiched therebetween. The primary image-transfer rolls 36 are each so configured as to be applied with, by a feeding unit (not shown), an image-transfer bias voltage whose polarity is opposite to that of the toner. With such a configuration, the toner images formed on the photosensitive elements 18 are transferred to the intermediate image-transfer belt 34.

On the other hand, a cleaning blade 46 is disposed on the side opposite to the side of the drive roll 38 with the intermediate image-transfer belt 34 sandwiched therebetween, and the tip end portion thereof is in contact with the intermediate image-transfer belt 34. This cleaning blade 46 is provided for eliminating any toner, paper dust, and others left on the intermediate image-transfer belt 34 moving in circulation.

### Paper Feed Cassette

Below the image-transfer unit 32 in the lower portion of the first housing 10A, two large-sized paper feed cassettes 48 are aligned in the horizontal direction for housing therein sheet members Peach being a recording medium. That is, the paper feed cassettes 48 can each house therein a large quantity of sheet members P. Note here that these two paper feed cassettes 48 are of the same configuration, and only one of the paper feed cassettes 48 is described but not the remaining paper feed cassette 48.

Such a paper feed cassette 48 is configured to be freely pulled out from the first housing 10A. When the paper feed cassette 48 is pulled out from the first housing 10A, a bottom plate 50 is moved down by a command from a control unit that is not shown. The bottom plate 50 is the one provided inside of the paper feed cassette 48, and the sheet members P are placed thereon. By the bottom plate 50 moving down as such, a user can refill the sheet members P.

On the other hand, when the paper feed cassette 48 is attached to the first housing 10A, the bottom plate 50 is moved up in response to a command coming from the control unit. Above the paper feed cassette 48 on one end side, a feed roll 52 is provided for feeding out the sheet members P from the paper feed cassette 48 onto a conveyance route 60. Such a feed roll 52 comes in contact with the sheet member P on the top on the moving-up bottom plate 50.

### Conveyance Route

On the downstream side of the feed roll 52 in the direction of conveying the sheet members (hereinafter, simply referred to as “downstream side”), a separation roll 56 is disposed for preventing the sheet members P from being fed plurally at a time. On the downstream side of such a separation roll 56, a plurality of conveyance rolls 54 are provided for conveying the sheet members P to the downstream side in the conveyance direction.

The conveyance route 60 provided between the paper feed cassettes 48 and the image-transfer unit 32 serves to provide the sheet member P coming from the paper feed cassette 48 to an image-transfer point T. The image-transfer point T is the portion where the secondary image-transfer roll 62 and the backup roll 42 nip the sheet member P therebetween. For such paper feeding, the conveyance route 60 is folded to be directed in the opposite direction at a first folding portion 60A, and then is folded to be directed in the opposite direction again at a second folding portion 60B.

Between the second folding portion 60B and the image-transfer point T, an aligner (not shown) is provided for adjusting the tilt or others of the sheet member P to be conveyed. Between such an aligner and the image-transfer point T, a positioning roll 64 is provided for adjusting the timing of conveying the sheet member P in motion with the movement of the toner image on the intermediate image-transfer belt 34.

The secondary image-transfer roll 62 is so configured as to be applied with, by a feeding unit (not shown), an image-transfer bias voltage whose polarity is opposite to that of the toner. With the secondary image-transfer roll 62 configured as such, the toner image of various colors being a result of the multi-layer image transfer onto the intermediate image-transfer belt 34 is subjected to secondary image transfer so that the toner image is transferred to the sheet member P coming along the conveyance route 60.

Moreover, an auxiliary path 66 is provided to extend from the side surface of the first housing 10A to meet the second folding portion 60A of the conveyance route 60. The sheet member P passes such an auxiliary route 66 to enter the conveyance route 60 after being sent out from an external large-capacity tray disposed adjacent to the first housing 10A.

### Vacuum Conveying Device

On the downstream side of the image-transfer point T, a plurality of vacuum conveying devices 70 are provided for conveying the sheet member P completed with the transfer of a toner image toward the second housing 10B.

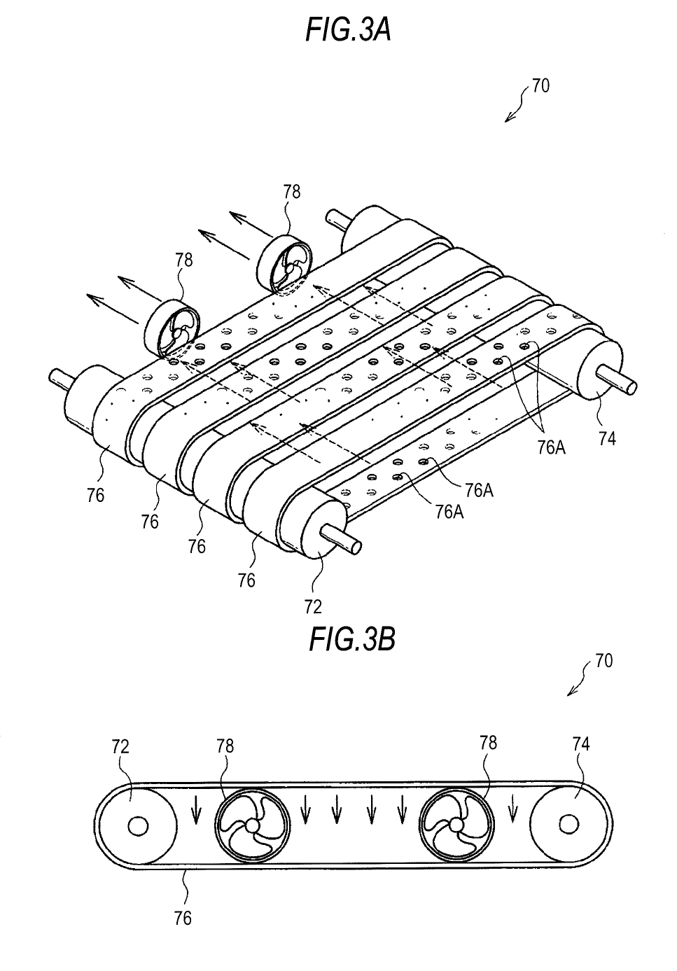

As shown in FIGS. 3A and 3B, the vacuum conveying devices 70 are each provided with a drive roll 72, a follower roll 74, and a plurality of belt members 76. The drive roll 72 is driven to rotate, and the follower roll 74 is supported to be able to rotate. The belt members 76 are those wound around the drive roll 72 and the follower roll 74.

The belt members 76 are each formed entirely thereover with a plurality of through holes 76A, and to suck the air from the through holes 76A to inside of the belt members 76, a suction fan 78 is disposed on the back side of the first housing 10A, i.e., on the side toward the depth of FIG. 1.

With such a configuration, the surface of the sheet member P not formed with a toner image, i.e., non-image surface, is brought to come in contact with the belt members 76, and the drive roll 72 is driven to rotate to rotate the belt members 76, thereby conveying the sheet member P to the downstream side.

The downstream side of the conveyance route 60 configured by the three vacuum conveying devices 70 is extended from the first housing 10A to the second housing 10B. The sheet member P sent out by the vacuum conveying devices 70 is received by another vacuum conveying device 80 provided inside of the second housing 10B, and the sheet member P is conveyed to the further downstream side.

On the downstream side of the vacuum conveying device 80 disposed inside of the second housing 10B, a fixing unit 82 is provided for fixing the toner image now on the surface of the sheet member P by heat and pressure.

### Fixing Unit

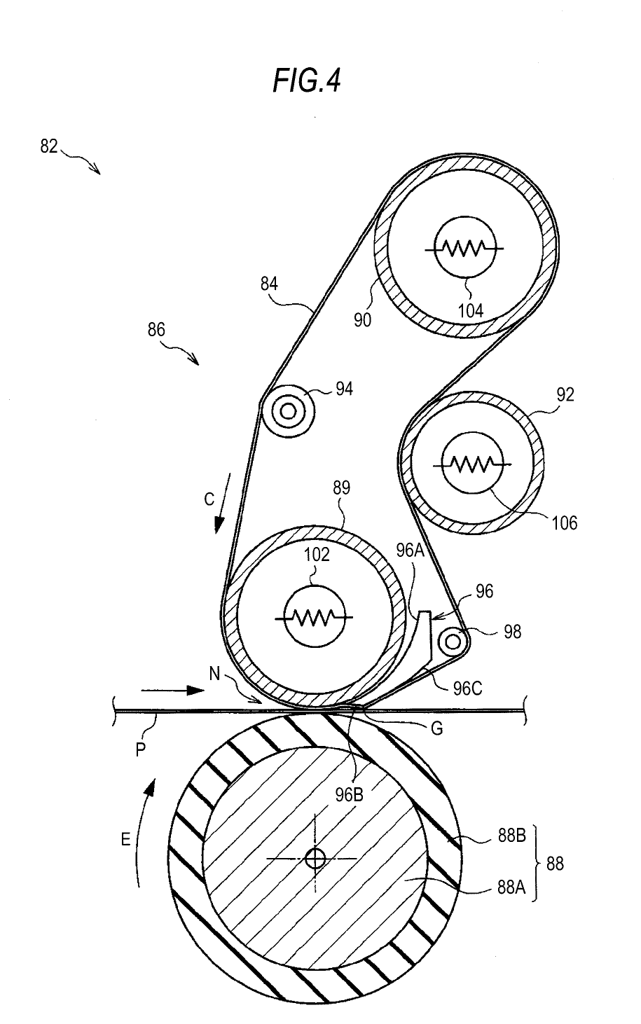

As shown in FIG. 4, this fixing unit 82 is configured to include a fixing belt module 86, and a pressure roll 88. The fixing belt module 86 is provided with a fixing belt 84, and the pressure roll 88 is so disposed as to be pressed against the fixing belt module 86 to come in contact therewith. Between the fixing belt module 86 and the pressure roll 88, a nip section N is formed for applying pressure and heat to the sheet member P to fix the toner image thereonto.

This fixing belt module 86 is configured to include the fixing belt 84, a heating roll 89, and a tension roll 90. The heating roll 89 is driven to rotate by the rotation force of a motor (not shown) while applying a tension to the fixing belt 84. The tension roll 90 serves to apply a tension to the fixing belt 84 from inside. The fixing belt module 86 is configured to include also a tension roll 92, and a posture correction roll 94. The tension roll 92 is provided to the outside of the fixing belt 84 for defining a circulation route therefor. The posture correction roll 94 is provided for correcting the posture of the fixing belt 84 between the heating roll 89 and the tension roll 90.

The fixing belt module 86 is configured to include also a peel pad 96, and a tension roll 98. The peel pad 96 is disposed in the vicinity of the heating roll 89 in a downstream area in the nip section N where the fixing belt module 86 and the pressure roll 88 are pressed against each other to come in contact. The tension roll 98 is wound around with a tension by the fixing belt 84 on the downstream side of the nip section N.

The heating roll 89 is a hard roll having a core roll, i.e., cored bar, in a cylindrical shape made of aluminum. Around the core roll, a fluoroplastics film with the thickness of 200 μm is formed as a layer for protecting the surface of the core roll from metal abrasion. The heat roll 89 is provided therein with a halogen heater 102 as a heating unit.

The tension roll 90 is a cylindrical roll made of aluminum, and is provided therein with a halogen heater 104 as a heating source, thereby heating the fixing belt 84 from the inner surface side thereof. The tension roll 90 is provided with, at each end portion, a spring member (not shown) that depresses the fixing belt 84 toward outside. With such a spring member, the tension of the fixing belt 84 is kept at 15 kgf in its entirety.

The tension roll 92 is also a cylindrical roll made of aluminum, and the surface thereof is formed with a release layer made of fluoroplastics with the thickness of 20 μm. This release layer is formed to prevent accumulation of, on the tension roll 92, any offset toner and paper dust although being slight in amount from the periphery surface of the fixing belt 84.

The tension roll 92 is provided therein with a halogen heater 106 as a heating unit, thereby heating the fixing belt 84 from the side of the periphery surface. That is, in this exemplary embodiment, the fixing belt 84 is heated by the various rolls, i.e., the heating roll 89, and the tension rolls 90 and 92.

The posture correction roll 94 is a circular-cylindrical roll made of aluminum, and in the vicinity thereof, a belt edge position detection mechanism (not shown) is disposed for detecting the edge position of the fixing belt 84. The posture correction roll 94 is provided with an axial displacement mechanism for changing the position to be abutted by the fixing belt 84 in the axial direction depending on the detection result of the belt edge position detection mechanism. Such a configuration is for controlling meandering of the fixing belt 84, i.e., belt walk.

The peel pad 96 is a block-shaped member formed by a rigid body made of metal such as SUS (stainless), resin, or others with the length corresponding to the heating roll 89. The peel pad 96 is configured to include an inner surface 96A, a depression surface 96B, and an outer surface 96C, and has the substantially arc-shaped cross section. The inner surface 96A is facing the heating roll 89, and the depression surface 96B serves to press the fixing belt 84 against the pressure roll 88. The outer surface 96C is placed with a predetermined angle to the depression surface 96B, and serves to bend the fixing belt 84.

More in detail, with an angle portion G between the depression surface 96B and the outer surface 96C, the fixing belt 84 is bent by being pushed against the angle portion G by the pressure roll 88, thereby preventing the tip end of the sheet member P from coming in contact with the fixing belt 84 when the tip end of the sheet member P passes by the angle portion G.

On the other hand, the pressure roll 88 is a soft roll configured by a circular-cylindrical roll 88A being a base made of aluminum, and is laminated by an elastic layer 88B and a peel-off layer in this order. The elastic layer 88B is 10 mm in thickness, and is made of silicone rubber with the hardness of 30° (JIS-A: (Japanese Industrial Standards-A). The peel-off layer is made of a PFA (Fluorine Plastic) tube with the film thickness of 100 μm. Such a pressure roll 88 is supported to be able to freely rotate, and is pressed against a portion of the fixing belt 84 to come in contact therewith. The portion of the fixing belt 84 here is the portion wound around the heating roll 89 by a biasing unit such as spring (not shown). As such, in response to when the heating roll 89 of the fixing belt module 86 is rotated to move in the direction of an arrow C, the pressure roll 88 follows the movement of the heating roll 89 to rotate to move in the direction of an arrow E.

### Paper Cooling Unit

As shown in FIG. 1, on the downstream side of the fixing unit 82, a vacuum conveying device 108 is provided for conveying the sheet member P sent out from the fixing unit 82 to the downstream side. On the downstream side of the vacuum conveying device 108, a cooling unit 110 is provided for cooling the sheet member P heated by the fixing unit 82.

The cooling unit 110 is configured to include a heat absorbing device 112 and a depression device 114 with the conveyance route 60 sandwiched therebetween. The heat absorbing device 112 is provided on one side, i.e., the upper side in this exemplary embodiment, for absorbing the heat of the sheet member P, and the depression device 114 is provided on the other side, i.e., the lower side in this exemplary embodiment, for pressing the sheet member P in motion against the heat absorbing device 112.

The heat absorbing device 112 is provided with a pulley-like heat absorbing belt 116 for absorbing the heat of the sheet member P by coming in contact therewith. Such a heat absorbing belt 116 is provided therein with a plurality of tension rolls 118, and a drive roll 120. The tension rolls 118 are those supporting the heat absorbing belt 116, and the drive roll 120 is for transmitting the drive force to the heat absorbing belt 116.

The heat absorbing belt 116 is also provided therein with a heat sink 122 made of an aluminum material for dissipating the heat absorbed by the heat absorbing belt 116 by a planar contact therewith.

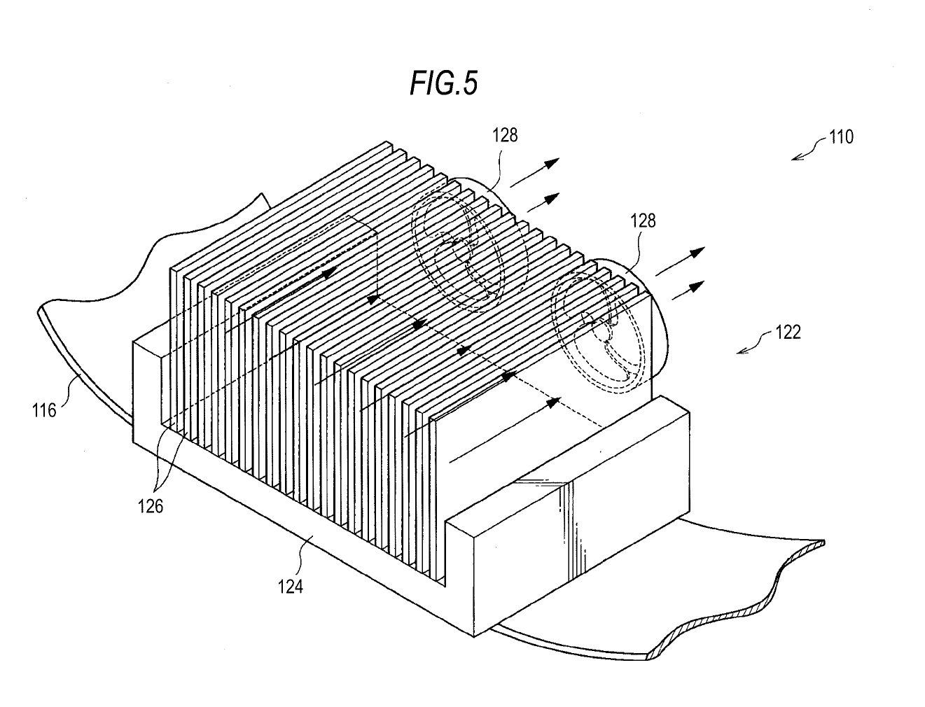

As shown in FIG. 5, the heat sink 122 is configured to include an abutting member 124, and a plurality of radiation plates 126. The abutting member 124 has the cross section in the shape of a square bracket, i.e., the upper portion thereof where the sheet member P abuts the heat absorbing belt 116 is left open. The radiation plates 126 are placed on such an abutting member 124 to receive the heat therefrom.

Moreover, for the purpose of catching the heat from the radiation plates 126 to release the heat therefrom to the outside, the suction fan 128 is disposed on the back side of the second housing 10B, i.e., on the side toward the depth of FIG. 1.

On the other hand, as shown in FIG. 1, the depression device 114 that presses the sheet member P in motion against the heat absorbing device 112 is provided with a pulley-like press belt 130, and a plurality of tension rolls 132. The press belt 130 comes in contact with the sheet member P, and presses the sheet member P against the heat absorbing device 112. The tension rolls 132 are each wound around with a tension by the press belt 130, and are supported to be able to rotate.

Such a configuration favorably enables to catch the heat of the sheet member P, thereby successfully cooling the sheet member P.

### Decal Processing Unit

On the downstream side of the cooling unit 110, a decal processing unit 140 is provided for straightening the sheet member P if it is curled.

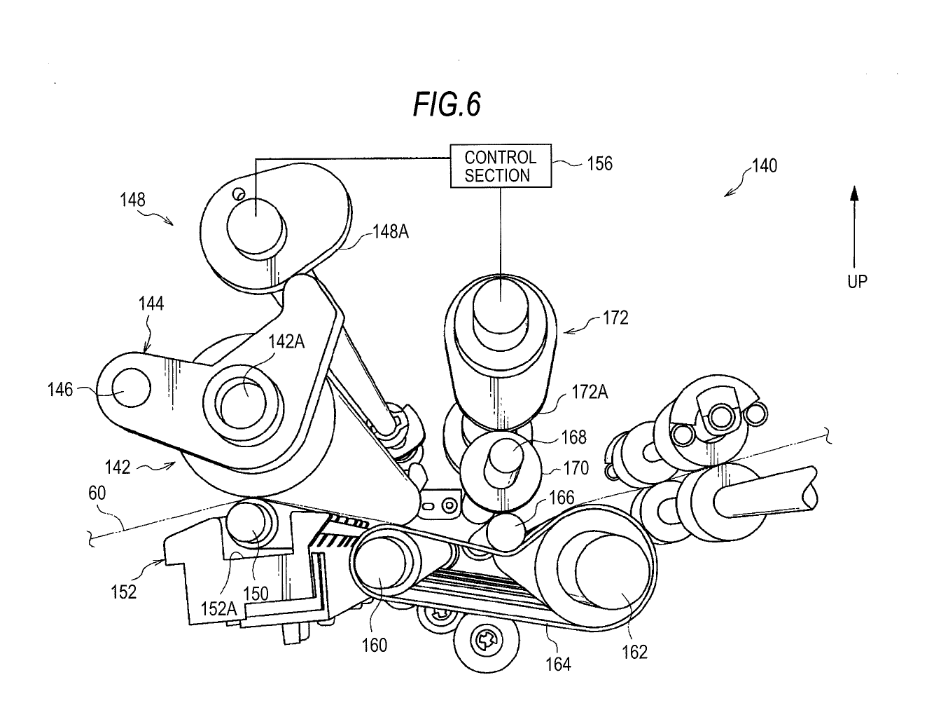

As shown in FIG. 6, on the upstream side of the decal processing unit 140 in the direction of conveying the sheet members (hereinafter, simply referred to as “upstream side”), a guide member 152 is provided for guiding the sheet member P. This guide member 152 is provided with a concave portion 152A whose upper side is left open.

The concave portion 152A is provided therein with a conveyance roll 150 that is pivotally supported by the device body to be able to rotate. To follow the movement of the conveyance roll 150 to rotate, an elastic roll 142 is provided to oppose the conveyance roll 150 with the conveyance route 60 sandwiched therebetween. The elastic roll 142 is made of an elastic member on the surface, and has a large diameter.

The elastic roll 142 has a rotation axis 142A, which is supported to be able to rotate toward the center of a bracket 144. The bracket 144 here is the one shaped like a plate whose center side is bent. One end side of this bracket 144 is supported by a frame member (not shown) to be able to rotate about an axis 146, and the remaining end side thereof is abutted to a cam surface 148A of a cam member 148 so that the bracket 144 is defined by position.

That is, by the restoring force of the elastic roll 142 generated by the deformation of the surface thereof as a result of abutting the conveyance roll 150, the end of the bracket 144 abutted to the cam surface 148A of the cam member 148 is biased by the cam surface 148A, thereby positioning the bracket 144.

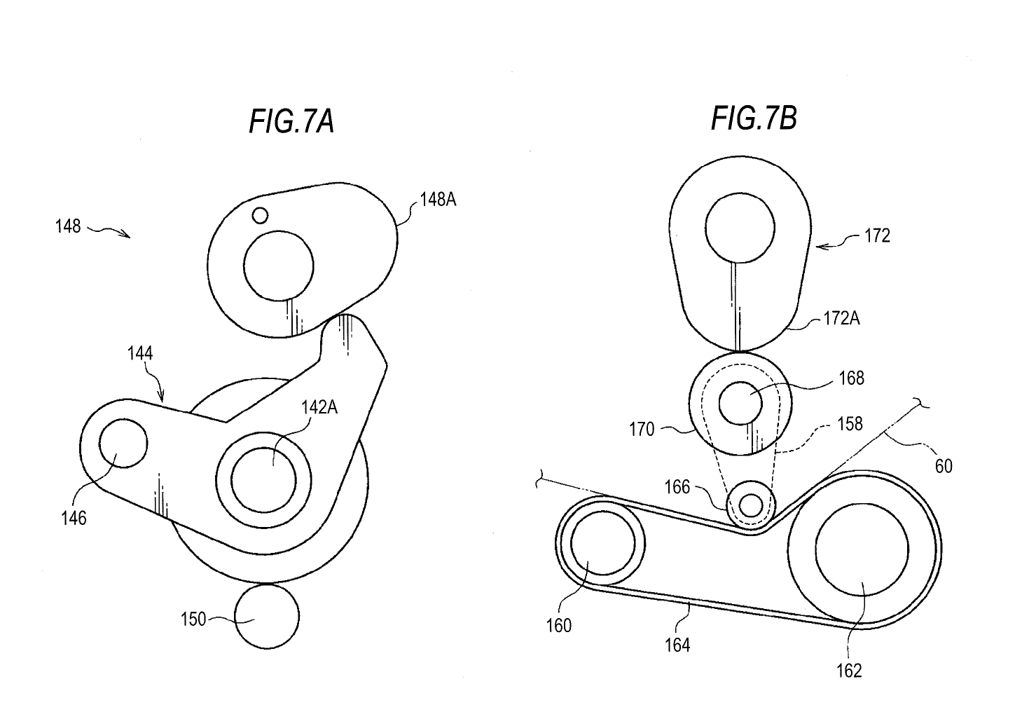

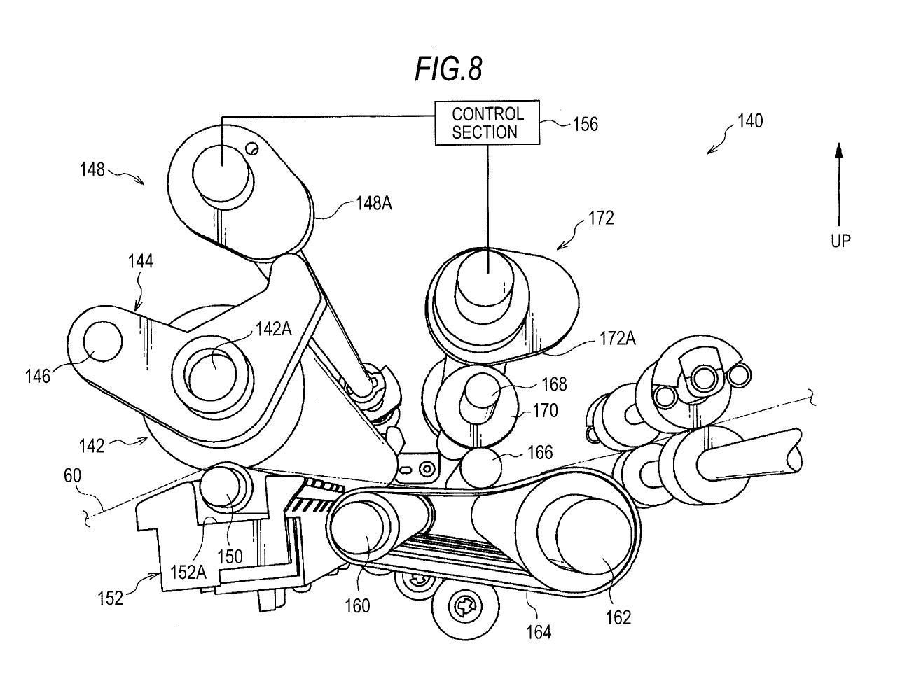

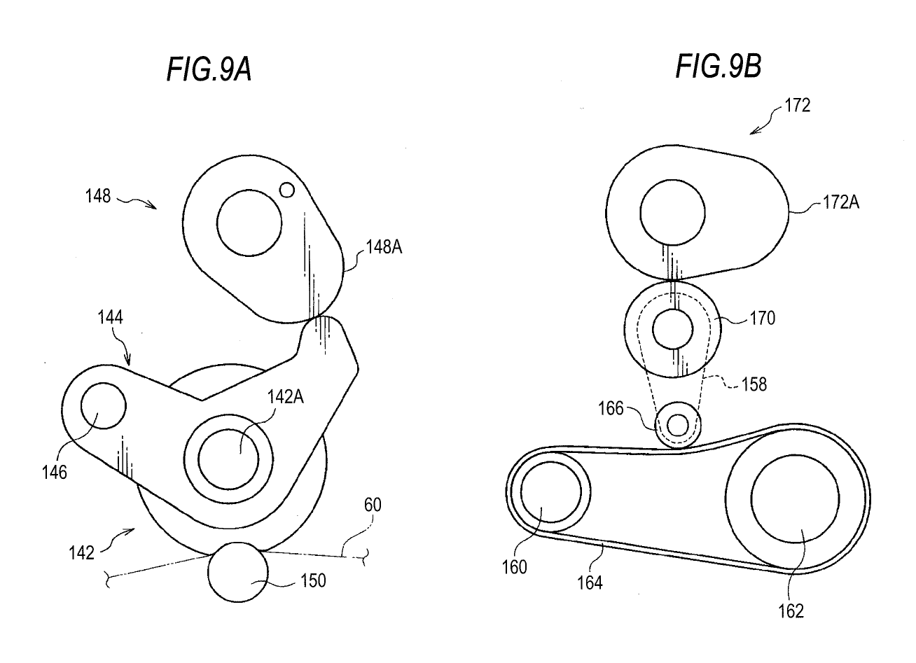

A control section 156 is provided for use to control the rotation angle of the cam member 148. The control section 156 rotates the cam member 148, and moves the elastic roll 142 to either position, i.e., a retreat position or a press position. At the retreat position (refer to FIGS. 6 and 7A), the elastic roll 142 is lightly pressed against the conveyance roll 150, and at the press position (refer to FIGS. 8 and 9A), the surface of the elastic roll 142 is elastically deformed by being strongly pushed against the conveyance roll 150, and the conveyance route 60 is deformed to look like a convex.

On the downstream side of the conveyance roll 150, tension rolls 160 and 162 are provided with a space therebetween in the horizontal direction. These tension rolls 160 and 162 are provided with a plurality of elastic belt members 164 whose upper surfaces serve as the conveyance route 60 for the sheet member P.

On the side opposite to the elastic belt members 164 with the conveyance route 60 sandwiched therebetween, a press roll 166 is provided to be able to rotate in such a manner as to depress the elastic belt members 164. On the side of the press roll 166 opposite to the elastic belt members 164, provided is a support roll 168 that is supported, at both end portions, to be able to rotate by a bracket 158 same as that of the press roll 166 (refer to FIG. 7B). The bracket 158 supporting, at both end portions, both the press roll 166 and the support roll 168 is supported by the device body to be able to move in a direction to come close to and away from the elastic belt members 164.

The support roll 168 supported to be able to rotate as such is provided with a circular press member 170 with a diameter larger than that of the support roll 168. The end surface of the press member 170 is abutted to a cam surface 172A of a cam member 172 provided on the upper portion of the support roll 168, thereby positioning the press member 170.

That is, by the restoring force of the elastic belt members 164 generated by the deformation thereof as a result of being abutted by the press roll 166, the press member 170 is biased by the cam surface 172A, thereby positioning the press member 170.

The control section 156 described above is also in charge of controlling the rotation angle of the cam member 172. The control section 156 rotates the cam member 172, and moves the press roll 166 to either position, i.e., a retreat position or a press position. At the retreat position (refer to FIGS. 8 and 9B), the press roll 166 is lightly pressed against the elastic belt members 164, and at the press position (refer to FIGS. 6 and 7B), the surfaces of the elastic belt members 164 are elastically deformed by being strongly pressed by the press roll 166, and the conveyance route 60 is deformed to look like a concave.

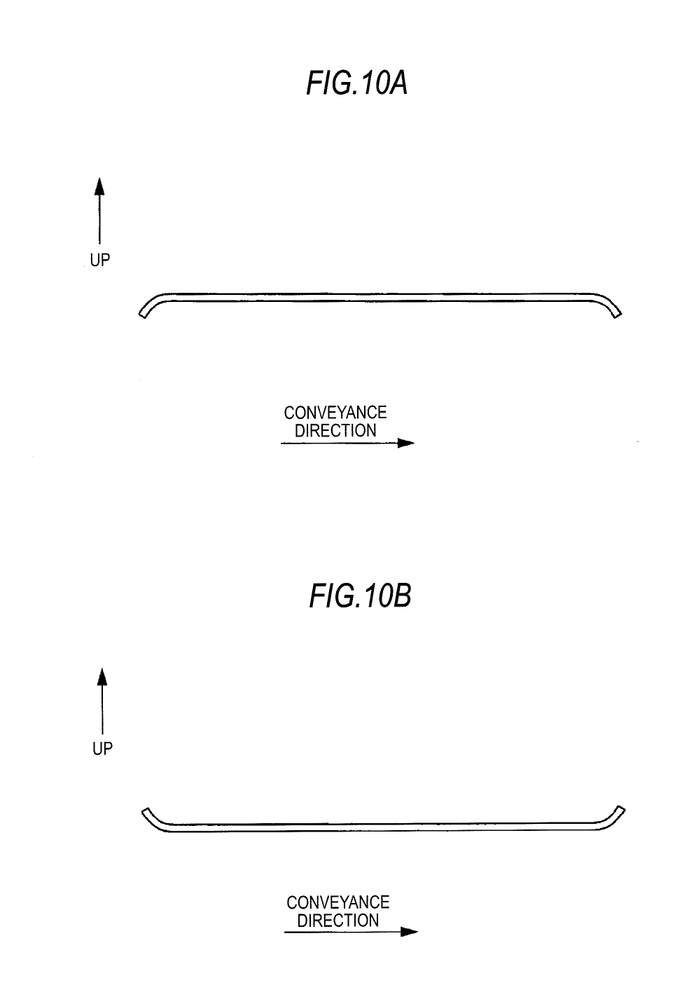

With such a configuration, as shown in FIG. 10A, when the sheet member P in motion is curled downward at an end portion(s), the control section 156 rotates the cam member 148 to move the elastic roll 142 to the retreat position (refer to FIGS. 6 and 7A). Thereafter, the control section 156 rotates the cam member 172 to move the press roll 166 to the press position (refer to FIGS. 6 and 7B), thereby deforming the conveyance route 60 to look like a concave. This accordingly straightens the downwardly-curled sheet member P.

On the other hand, as shown in FIG. 10B, when the sheet member P in motion is curled upward at an end portion(s), the control section 156 rotates the cam member 172 to move the press roll 166 to the retreat position (refer to FIGS. 8 and 9B). Thereafter, the control section 156 rotates the cam member 148 to move the elastic roll 142 to the press position (refer to FIGS. 6 and 7B), thereby deforming the conveyance route 60 to look like a convex. This accordingly straightens the upwardly-curled sheet member P.

The direction and degree of curling of the sheet member P vary depending on various factors, i.e., about the sheet member P such as the type, e.g., plain paper or coated paper, the weight (g/m²), the size, and the feeding direction, the density of image (can be estimated by image data information to the light exposure units), or the shape of a paper-running path that varies depending on which device, and the characteristics of a unit(s) disposed on such a path. The control section 156 then refers to the image data information described above to estimate the direction and degree of curling, and based on the estimation result, changes the rotation angles of the cam members 148 and 172 to adjust the surface condition, i.e., convex or concave, of the conveyance route 60.

### In-Line Sensor Unit

As shown in FIG. 1, on the downstream of the decal processing unit 140, an in-line sensor unit 180 is provided to detect any deficiency of the toner image fixed on the sheet member P. The deficiency includes toner density deficiency, image deficiency, image position deficiency, and others.

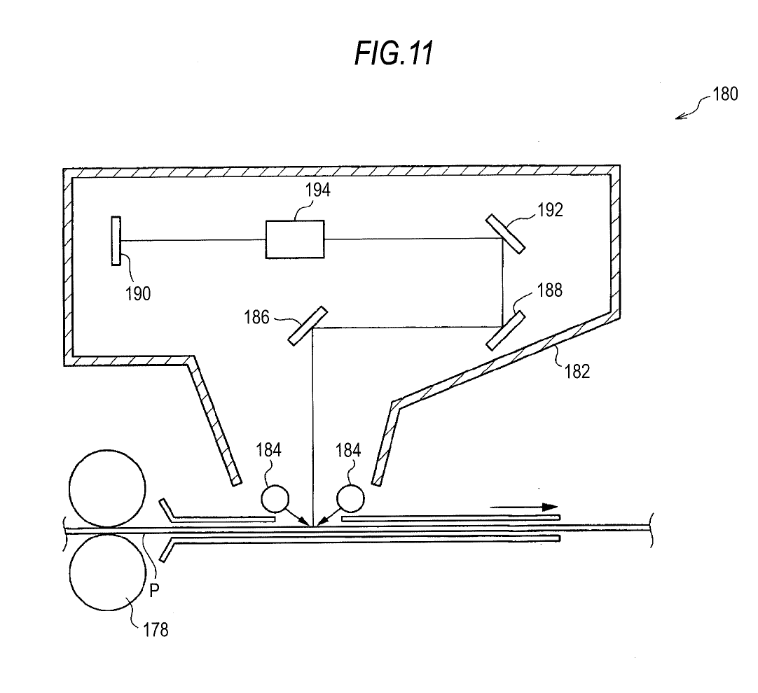

As shown in FIG. 11, a housing 182 of the in-line sensor unit 180 is provided therein with two light-emission members 184 for each directing a light to the sheet member P being conveyed by the conveyance roll 178. The housing 182 is also provided therein with mirrors 186 and 188. The mirror 186 serves to reflect, toward the side, lights from the light-emission members 184 reflected upward by the sheet member P. The mirror 188 serves to reflect upward the reflection lights directed toward the side by the mirror 186. A mirror 192 is also provided, and with which the reflection lights directed upward by the mirror 188 are directed toward a CCD (Charge-Coupled Device)-type optical sensor 190. Between the mirror 192 and the optical sensor 190, a light-gathering lens 194 is provided for use to gather the reflection lights to the optical sensor 190.

With such a configuration, the optical sensor 190 is enabled to detect any deficiencies, e.g., toner density deficiency, image deficiency, image position deficiency, and others.

### Reverse Unit

As shown in FIG. 1, on the downstream of the in-line sensor unit 180, an ejection roll 198 is provided for ejecting the sheet member P formed with an image on one plane, i.e., surface, to an ejection tray 196, which is attached to the side surface of the second housing 10B.

For forming an image on each of the surfaces, the sheet member P coming from the in-line sensor unit 180 is directed to a reverse unit 200, which is disposed on the downstream of the in-line sensor unit 180.

More in detail, by a switch member that is not shown, the sheet member P is guided to a reverse route 202 provided to the reverse unit 200.

The reverse route 202 is configured to include a branch path 202A, and a paper conveyance path 202B. The branch path 202A is a branch of the conveyance route 60, and the paper conveyance path 202B extends in the horizontal direction to direct the sheet member P coming along the branch path 202A toward the image-transfer unit 32.

The reverse route 202 is provided also with a reverse path 202C extended in the horizontal direction to turn over the sheet member P, i.e., is folded to direct opposite to the paper conveyance path 202B, is provided with the sheet member P from the tip end portion thereof, and forwards the provided sheet member P from the rear end portion thereof toward the image-transfer unit 32, i.e., conveyance in a switch-back manner.

More in detail, the paper conveyance path 202B and the reverse path 202C are so disposed as to have at least an overlap therebetween in the vertical direction, i.e., vertical direction in FIG. 1, and are parallel to each other when viewed from the front of the second housing 10B (device), i.e., in the direction of FIG. 1.

Moreover, the paper conveyance path 202B and the reverse path 202C are disposed on the lower portion of at least either the fixing unit 82 or the cooling unit 110, i.e., disposed on the lower portion of the cooling unit 110 in this exemplary embodiment.

With such a configuration, the sheet member P conveyed on the reverse path 202C in a switch-back manner is directed toward the first housing 10A, and then onto the conveyance route 60 located on the upper portion of the paper feed cassettes 48, thereby directing again the sheet member P to the image-transfer point T.

### Power Unit

Described next is a power unit 210 that takes the alternating current from the outside.

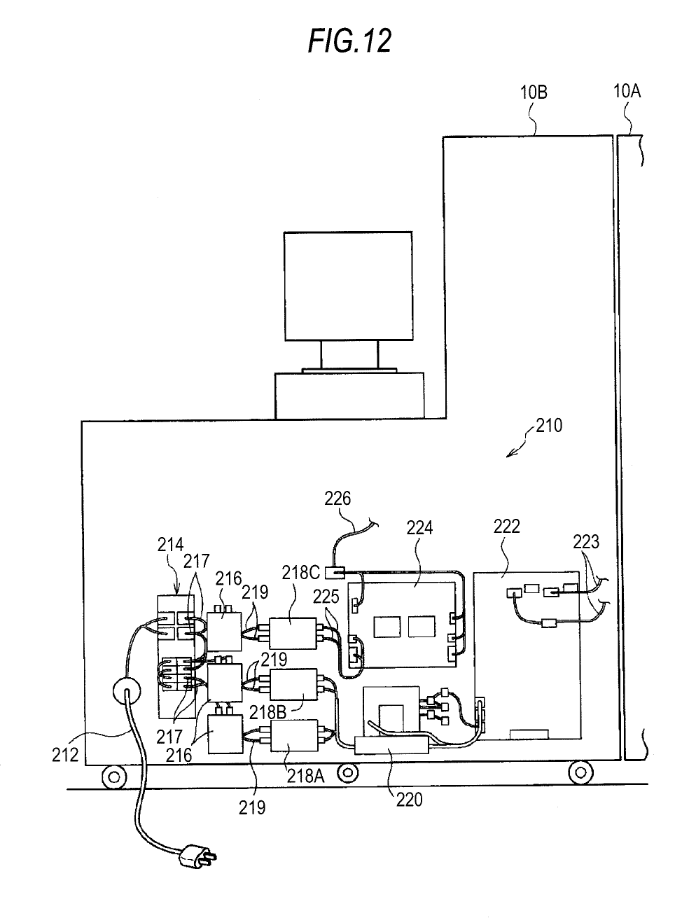

As shown in FIG. 12, the power unit 210 is provided on the back surface, i.e., rear surface, of the second housing 10B. The power unit 210 is provided with an input power supply code 212 for use to take the alternating current from the outside. The input power supply code 212 is connected with an end of a splitter 214 that splits the alternating current. The other end of the splitter 214 is connected with, via a wiring code 217, an end of a breaker 216 that reduces the overcurrent.

The other end of the breaker 216 is connected with, via a wiring code 219, one ends of noise filters 218A, 218B, and 218C that all reduce any noise of the alternating current. The remaining ends of the noise filters 218A and 218B are connected with, via a transformer 220, an end of a control substrate 222 for use by the fixing unit 82 (refer to FIG. 1). The transformer 220 is the one used for voltage increase and reduction.

On the other hand, the remaining end of the noise filter 218C is connected to, via a wiring code 225, one end of a control substrate 224 for constant-voltage power supply use. The other end of the control substrate 224 is connected to, via a wiring code 226, a power supply unit 230 (refer to FIG. 1) that changes the alternating current to the direct current.

The other end of the control substrate 222 is connected to the fixing unit 82 (refer to FIG. 1) via a wiring code 223 so that the fixing unit 82 requiring a large output is provided with the alternating current via the control substrate 222.

On the other hand, as shown in FIG. 1, the power supply unit 230 connected with the control substrate 224 via the wiring code 226 is disposed inside of the second housing 10B between the fixing unit 82 and the image signal processing section 13. With such a configuration, the direct current being the result of conversion by the power supply unit 230 is provided to the units other than the fixing unit 82, e.g., the image forming unit 16 and others.

### Effects

Described next is an image forming process to be executed by the image forming device 10.

As shown in FIG. 12, the alternating current taken from the outside via the input power supply code 212 is directed to the power unit 210 disposed on the back surface of the second housing 10B, i.e., first provided to the fixing unit 82 provided inside of the second housing 10B via the control substrate 222, and then to the power supply unit 230 provided also inside of the second housing 10B via the control substrate 224.

As shown in FIG. 1, the alternating current provided to the power supply unit 230 is converted into the direct current, and then the resulting direct current is provided to each of the units so that the units are activated to operate.

The image data completed with the image processing by the image signal processing section 13 activated as such to operate is converted into gray-scale data about a color material varying in color, and the resulting data is sequentially output to the light exposure units 40. The light exposure units 40 each output a light-exposure light L in accordance with the gray-scale data of the color material varying in color. The light exposure units 40 then respectively perform scanning light exposure to the photosensitive elements 18 charged by the scorotron chargers 20, thereby forming a latent image, i.e., electrostatic latent image.

As shown in FIG. 2, the electrostatic latent images respectively formed on the photosensitive elements 18 are elicited, before being developed, by the developing devices 22 as toner images (developing-agent images) varying in color, i.e., first special color (V), second special color (W), Yellow (Y), Magenta (M), Cyan (C), and Black (K).

As shown in FIG. 1, the toner images varying in color sequentially generated on the photosensitive elements 18 of the image forming units 16V, 16W, 16Y, 16M, 16C, and 16K, are subjected to multi-layer image transfer one by one onto the intermediate image-transfer belt 34 by the six primary image-transfer rolls 36V, 36W, 36Y, 36M, 36C, and 36K.

The toner images varying in color completed with the multi-layer image transfer onto the intermediate image-transfer belt 34 are subjected to secondary image transfer by the secondary image-transfer roll 62 onto the sheet member P coming from the paper feed cassettes 48. The sheet member P completed with the transfer of the toner images as such is directed to the fixing unit 82 provided inside of the second housing 10B by the vacuum conveyance devices 70.

The toner images varying in color on the sheet member P are fixed thereon by being heated and pressured by the fixing unit 82. The sheet member P completed with the fixing of the toner images as such is cooled by passing through the cooling unit 110, and then is forwarded to the decal processing unit 140, thereby straightening the sheet member P if it is curled.

The sheet member P completed with the curling straightening as such is subjected to a detection of image deficiency or others by the in-line sensor unit 180, and then is ejected to the ejection tray 196 by the ejection roll 198.

On the other hand, for forming an image on the surface not yet formed with an image, i.e., no-image surface, i.e., for two-sided image formation, the sheet member P is forwarded to the reverse unit 200 by a switch member (not shown) after the sheet member P passes through the in-line sensor unit 180. The sheet member P directed to the reverse unit 200 as such is turned over after passing through the reverse route 202, and then is directed to the conveyance route 60 provided to the upper portion of the paper feed cassettes 48, whereby the underside of the sheet member P is formed with a toner image.

More in detail, the sheet member P guided to the reverse route 202 is conveyed along the branch path 202A being a branch of the conveyance route 60, and then is conveyed along the paper conveyance path 202B after passing through the branch 202A. As such, the sheet member P is directed to the image-transfer unit 32.

Thereafter, the reverse path 202C folded to direct opposite to the paper conveyance path 202B turns over the sheet member P by receiving the sheet member P in motion from the front end portion thereof and then by forwarding the provided sheet member P from the rear end portion thereof, i.e., conveyance in a switch-back manner, thereby directing the sheet member P again to the conveyance route 60.

Herein, as described above, the paper conveyance path 202B and the reverse path 202C provided to the reverse route 202 are so disposed as to have at least an overlay therebetween in the vertical direction. That is, with such a layout, the reverse path 202C does not extend in the horizontal direction with respect to the paper conveyance path 202B, thereby favorably preventing the size increase of the second housing 10B in the horizontal direction.

The paper conveyance path 202B and the reverse path 202C are parallel to each other when viewed from the front of the second housing 10B, i.e., from the direction of FIG. 1. That is, with such a layout, the second housing 10B is prevented from increasing in size in the vertical direction.

The paper conveyance path 202B and the reverse path 202C are both disposed on the lower portion of the cooling unit 110. That is, with such a vertical arrangement that the set of the paper conveyance path 202B and the reverse path 202C is disposed below the cooling unit 110, the layout inside of the second housing 10B can be compact.

Moreover, the components, i.e., the paper conveyance path 202B, the reverse path 202C, and the fixing unit 82, are provided to the second housing 10B that can be separated from the first housing 10A. That is, the layout can be simplified.

While the exemplary embodiment of the invention has been described in detail, the foregoing description is in all aspects illustrative and not restrictive. It is understood that numerous other modifications and variations can be devised without departing from the scope of the invention. In the exemplary embodiment described above, exemplified is the case of making the layout compact in the second housing 10B by disposing the paper conveyance path 202B and the reverse path 202C below the cooling unit 110. This is surely not restrictive, and the layout in the second housing 10B may be made compact by disposing the paper conveyance path 202B and the reverse path 2020 below the fixing unit 82.

What is claimed is:

1. An image forming device, comprising:
an image forming unit that forms a toner image;
an image-transfer unit that transfers the toner image formed by the image forming unit onto an recording medium;
a fixing unit that fixes the toner image transferred on the recording medium by the image-transfer unit;
a conveyance path that guides the recording medium toward the image-transfer unit by changing a conveyance direction of the recording medium fixed with the toner image by the fixing unit; and
a reverse path that has at least a partial overlap with the conveyance path in a vertical direction by being folded in a direction opposite to a direction of the conveyance path, and turns over the recording medium by conveying the recording medium toward the image-transfer unit from a front end portion of the recording medium to a rear end portion of the recording medium.

2. The image forming device according to claim 1, wherein the conveyance path and the reverse path are disposed to be parallel to each other when viewed from the front of the device.

3. The image forming device according to claim 1, further comprising: a cooling unit provided on a downstream side of the fixing unit in the conveyance direction of the recording medium for cooling the recording medium fixed with the toner image by the fixing unit,
wherein the conveyance path and the reverse path are disposed on a lower portion of at least either of the fixing unit or the cooling unit.

4. The image forming device according to claim 2, further comprising: a cooling unit provided on a downstream side of the fixing unit in the conveyance direction of the recording medium for cooling the recording medium fixed with the toner image by the fixing unit,
wherein the conveyance path and the reverse path are disposed on a lower portion of at least either of the fixing unit or the cooling unit.

5. The image forming device according to claim 1, further comprising:
a first housing including a conveyance route of directing the recording medium toward the image-transfer unit after receiving the recording medium from the reverse path, the image-forming unit, and the image-transfer unit; and
a second housing provided to be separatable from the first housing, and including the fixing unit, the conveyance path, and the reverse path.

6. The image forming device according to claim 2, further comprising:
a first housing including a conveyance route of directing the recording medium toward the image-transfer unit after receiving the recording medium from the reverse path, the image-forming unit, and the image-transfer unit; and
a second housing provided to be separatable from the first housing, and including the fixing unit, the conveyance path, and the reverse path.

7. The image forming device according to claim 3, further comprising:
a first housing including a conveyance route of directing the recording medium toward the image-transfer unit after receiving the recording medium from the reverse path, the image-forming unit, and the image-transfer unit; and
a second housing provided to be separatable from the first housing, and including the fixing unit, the conveyance path, and the reverse path.
